(19) United States
(12) Patent Application Publication
(10) Pub. No.: US 2009/0083807 A1
(43) Pub. Date: Mar. 26, 2009

(54) DIGITAL CONTENT DISTRIBUTION SYSTEM

(76) Inventors: Carla A. Stephan, San Diego, CA (US); Gabriel Mendoza, Los Gatos, CA (US); Gabriel B. Begel-Dov, Corvallis, OR (US); Raoul Heinze, Vancouver, WA (US); Yevgeniy Eugene Shteyn, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/858,729

(22) Filed: Sep. 20, 2007

(51) Int. Cl. H04N 7/173

(52) U.S. Cl. 725/87

(57) ABSTRACT

Embodiments of a digital content distribution system are disclosed.

### BACKGROUND

With the advent of digital versatile discs (DVDs), consumers have enjoyed a sleek new way of buying or renting movies or other programs at a retail store and then viewing the movies in the privacy of their homes. However, the selection of movies for consumers in the DVD format has been limited to the most popular movies and programs. This situation arises, in part, due to the decision by the producers and distributors of the DVDs that the high cost of producing the DVDs is worthwhile for highly popular movies but generally not worthwhile for movies of low popularity.

Meanwhile, the internet has provided another way for a consumer to obtain a movie via downloading and has offered many more titles from which the consumer can select. However, numerous difficulties persist in this market including bandwidth limitations, lack of adequate computing resources by many consumers, and the other vagaries of the internet when downloading files.

Accordingly, while consumers are enticed by new freedoms as the frontier of new media is explored, their freedom has been quickly bounded by the limits of these new technologies.

### BRIEF DESCRIPTION OF THE DRAWINGS

FIG. 1 is a block diagram illustrating a digital content distribution system, according one embodiment of the present disclosure.

FIG. 2 is a block diagram illustrating a promotion provider of a digital content distribution system, according to one embodiment of the present disclosure.

FIG. 3 is block diagram illustrating a node of a storage network of a digital content distribution system, according to one embodiment of the present disclosure.

FIG. 4 is a flow diagram illustrating a method of digital content distribution, according to one embodiment of the present disclosure.

FIG. 5 is block diagram illustrating a digital content distribution system, according to one embodiment of the present disclosure.

### DETAILED DESCRIPTION

In the following detailed description, reference is made to the accompanying drawings which form a part hereof, and in which is shown by way of illustration specific embodiments in which the subject matter of the present disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

Embodiments of the present disclosure are directed to distributing digital content. In one embodiment, a user obtains a DVD package through a brick-and-mortar retailer or an on-line retailer. The DVD package includes one conventional DVD including a first digital content item, such as a movie, a sporting event, or other program. However, in one aspect of the present disclosure, the DVD package also includes at least one portable memory media, such as a promotional DVD including a partial second digital content item different than the first digital content item. The partial second digital content item comprises a first chapter of a movie, a first part of an event or program, and/or other promotional materials such as a video trailer, photos, etc.

In one aspect, the consumer plays, via a media player, the partial second digital content item on the promotional DVD. If the consumer likes the partial second digital content item, the consumer orders for purchase, from a service provider, a complementary second digital content item related to the partial second digital content item. In one aspect, the complementary second digital item comprises a second chapter or remaining chapters of the movie (or sporting event, program, etc.) to complement the first chapter of the movie in the partial second digital content item on the promotional DVD. In one embodiment, the partial second digital content item and the complementary second digital content item together add up to a complete second digital content item, such as a full length movie. In another embodiment, the partial second digital content item comprises a first television program in a series and the complementary second digital content item comprises one or more additional program in the same series of television programs.

In one aspect, prior to the consumer's purchase of the DVD package, the complementary digital content item has already been stored at a local storage network provider to be available for rapid downloading by the consumer. Accordingly, the consumer downloads, via a network communication link, to the media player the complementary digital content item from the local storage network provider to enable the consumer to watch and/or store the complementary digital content item on the media player.

With this arrangement, the consumer is provided with an opportunity to sample a second digital content item, in addition to a first digital content item in the DVD package. Meanwhile, a fast download mechanism is provided via the local storage network provider so that if the consumer is enticed by the samples of the second digital content items, they do not have to wait long to view additional portions of the second digital content item(s).

While the consumer enjoys this new convenience, a promotional provider uses this arrangement to leverage the consumer's existing interest in the first DVD into other digital content via the promotional DVD. In particular, by including the promotional DVD, the promotional provider aims to “prime-the-pump” for other digital content items that are soon to be released in the theatre, on DVD, or via media-on-demand (e.g., pay-per-view, video-on-demand, etc.). Accordingly, the promotional provider orchestrates the timing of the promotional DVD to be viewed by consumers on their media players concurrently with, or prior to, the expected release dates of the to-be-promoted digital content items. In other words, the partial digital content items on the second DVD are directly related (e.g., prequel, sequel, etc.) to a soon-to-be released item or fall within the same genre of the soon-to-be released item.

Moreover, because the second DVD is not limited to a partial second digital content item, the second DVD has enough room to store several other partial digital content items (e.g., third, fourth, fifth partial digital content items). Accordingly, this feature gives the promotional provider the power to promote, not just one movie, but instead the power to promote several movies (or other programs) at once with each different partial digital content item possibly enticing the consumer into a download purchase of its related complementary digital content item.

In addition, the promotional DVD can include photos, advertisement, and/or bonus material (e.g., games, technical effects, etc.) related to the complementary digital content items or related to the soon-to-be released digital content items (i.e., theatre release items, main title DVD releases, etc.) that the partial digital content item is intended to promote.

In another embodiment, the at least one portable memory media (that stores the partial digital content item) is not limited to a DVD. Accordingly, in one embodiment, the at least one portable memory media is digital memory device that includes, but is not limited to, a flash card, a USB thumb drive, a memory stick, a portable hard drive, or a memory spot.

In another embodiment, the media player is not limited to a DVD player but includes any media player suitable for playing various types and formats of portable memory media including those identified above. Accordingly, in one embodiment, the media player includes but is not limited to a personal computer, a personal server, a television, a set-top box, a game console, a portable media player, a personal digital assistant, a wireless phone, a handheld computer, or a software application on a hardware device.

In another embodiment, the at least one portable memory media is provided or sold with items other than DVDs. Accordingly, in one embodiment, a retail package includes a consumer item and the at least one portable memory media, wherein the consumer item includes, but is not limited to, a printed media item, a digital memory drive, a digital memory card, a photo CD, an audio CD, a DVD, a consumer electronics appliance, a household appliance, a personal computer, a computer peripheral, a furniture item, a packaged food item (e.g., cereal), a clothing item, a toy, or a tool.

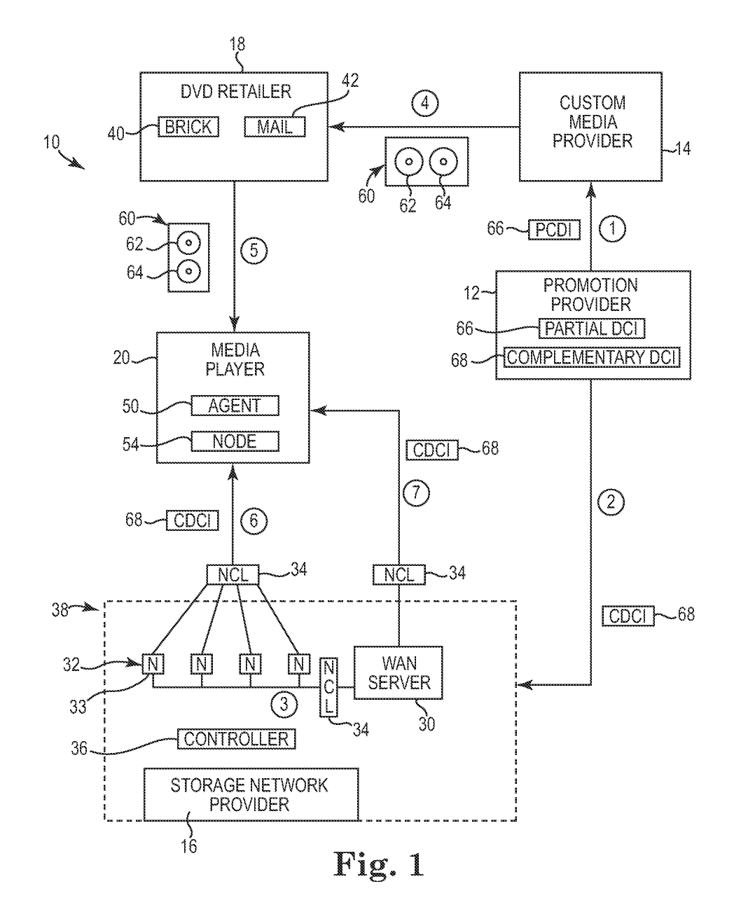

These embodiments, and additional embodiments, are described in association with FIGS. 1-5.

FIG. 1 is block diagram illustrating a digital content distribution system, according to one embodiment of the present disclosure. As illustrated in FIG. 1, system 10 comprises a promotion provider 12, a custom media provider 14, a storage network provider 16, a DVD retailer 18, and a consumer's media player 20.

The promotion provider 12 is configured to orchestrate a promotional campaign that promotes and sells digital content items via a staged delivery mechanism that includes both a physical delivery pathway (e.g., a retail store) and an electronic delivery pathway (e.g., downloading via a network communication link). The physical delivery pathway delivers a limited portion of a promotional digital content item while the electronic delivery pathway delivers a second portion or a remaining portion of that same digital content item. Using both the physical delivery pathway and the electronic delivery pathway, the consumer receives an entire digital content item.

However, the promotion provider 12 also uses these delivery pathways to promote other digital content items that are soon-to-be released in theatres, on DVD, via media-on-demand, or on television. Accordingly, this promotional DVD is a dual purpose tool which is both targeted to drum up interest in the soon-to-be released digital content item (e.g., a theatre release, a retail DVD release, etc.) and to simultaneously promote and sell the complementary digital content items available via download.

In one aspect, according to specifications provided by the promotion provider 12 (as represented by path 1 as illustrated in FIG. 1), the custom media provider 14 produces a DVD package 60 including a conventional DVD 62 and at least one promotional DVD 64. The conventional DVD 62 contains a full length movie, complete sporting event, or other program. In another aspect, each promotional DVD 64 includes at least one partial digital content item 66 provided via promotion provider 12, such as a first chapter of a movie (or program, event, etc.), as well as other promotional materials, such as advertisements, photos, bonus materials, and/or incentives. The custom media provider 14 is configured to obtain and/or receive digital content items from a content provider at the request of the promotion provider 12. In some instances, the promotion provider 12 provides the digital content items directly to the custom media provider 14.

In one aspect, custom media provider 14 also receives from promotion provider 12 a locality identifier for placement on the promotional DVD. This locality identifier assists the promotion provider 12, and the storage network provider 16, in promoting digital content items and in pre-populating the local storage network (e.g., peer-to-peer network 38) with digital content items to be downloaded by a consumer.

As represented by path 4 in FIG. 1, the DVD retailer 18 receives the DVD package 60 from custom media provider 14 and places the DVD package 60 on retail sale to consumers. In one aspect, the DVD retailer 18 comprises a brick-and-mortar retailer 40, such as local video store, department store, etc. In another aspect, the DVD retailer 18 comprises a mail retailer 42 configured to deliver a DVD package to a consumer via the mail and in which the consumer orders the DVD package via mail order, via a web site (i.e., on-line), or via telephone.

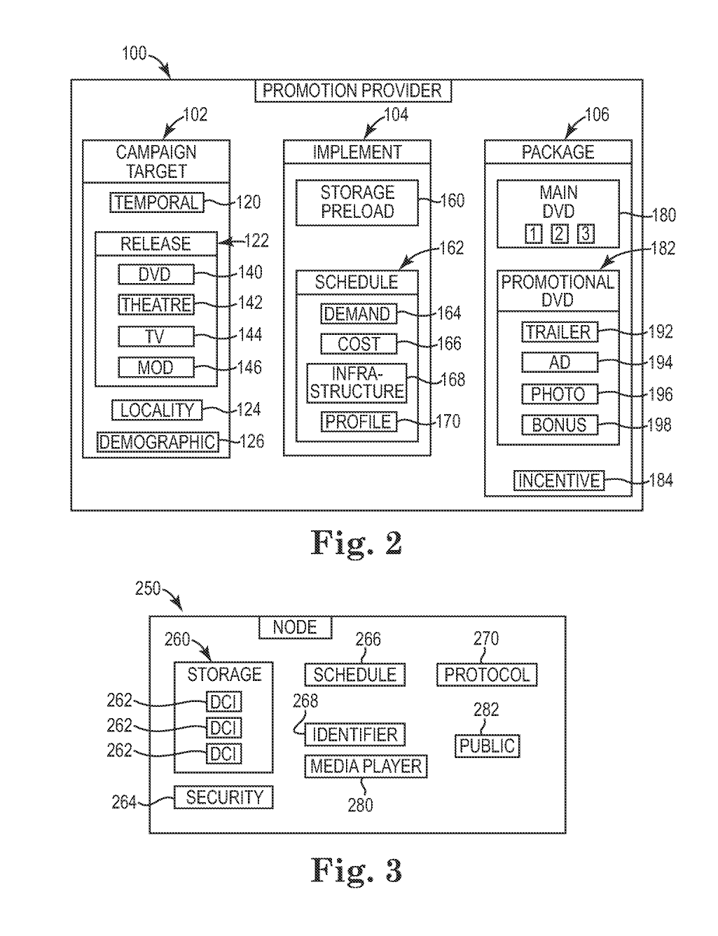

In one embodiment, the retail DVD package 60 includes a Stock Keeping Unit (SKU) identifier that is associated with a combination of conventional and promotional DVDs. When the consumer's address becomes at least partially known, either by a shipping address or by an address associated with the consumer's payment option (such as credit or debit card, mobile phone, promotional coupon, etc.), the SKU identifier and the address information are forwarded to promotion provider 12 or its agent. The information is used to determine an optimal pathway configuration for delivering complementary digital content items, as later described more fully in association with service network provider 16. In one embodiment, the SKU identifier functions as, or in cooperation with, locality identifier 124 as later described in more detail in association with campaign target module 102 of promotion provider 100 in FIG. 2.

The consumer takes the DVD package 60 (as represented by path 5) home or to another location and uses the media player 20 to typically view the conventional DVD 62 that was intended to be purchased. In addition, using media player 20, the consumer views the promotional DVD 64 of the DVD package 60 that includes the partial digital content item (PDCI) 66. In one embodiment, media player 20 comprises a DVD player or an application on the DVD player. In another embodiment, media player 20 comprises any other network attached device, such as personal computer, a television, a home server, a set-top box, a game console, a portable media player, a portable hard, a personal digital assistant, a handheld computer, or a wireless phone.

While the custom media provider 14 receives a partial digital content item 66, the promotion provider 12 directs the complementary digital content item 68 (related to the partial digital content item (PDCI) 66) to storage network provider 16, as represented by path 2 as illustrated in FIG. 1, for storage in a local network such as a peer-to-peer network 38. The promotional provider 12 or its agent may also forward to the storage network provider 16 a pathway-related configuration information to optimize delivery options. Accordingly, the storage network provider 16 is configured to provide generally local storage of complementary digital content items (CDCI) 68 in a distributed arrangement for quick downloading to media player 20 to save the consumer from a time-consuming conventional download from a single network source. In one embodiment, the storage network provider 16 operates a peer-to-peer network 38 including an array 32 of nodes 33 with each node 33 including storage capability and in cooperative communication with other nodes 33. Accordingly, as represented by path identifier 3 as illustrated in FIG. 1, the complementary digital content (CDCI) 68 is stored in a distributed manner among nodes 33 in the peer-to-peer network 38 under the control of storage network provider 16.

In one embodiment, the complementary digital content item (CDCI) 68 is first sent to a WAN server 30 in a relationship with, or under the control of, storage network provider 16. In one aspect, the complementary digital content item (CDCI) 68 is sent to the WAN server 30 at low traffic periods on the internet. The WAN server 30 then pre-populates the nodes 33 of peer-to-peer network 38 so that complementary digital content item (CDCI) 68 is stored in one or more nodes 33 for future downloading to media player 20. In another aspect, one or more different portions of a complementary digital content item (CDCI) 68 are stored in a distributed manner among one or more different nodes 33 as well.

In another embodiment a pre-populated content node 33 comprises a publicly accessible site (i.e., is co-located with a public site) including, but not limited to, a Wi-Fi® hot spot, an internet cafe, a restaurant internet access site, a public facility access site, or an internet access rental kiosk. In one aspect, promotional content including a partial digital content item (PDCI) 66 is delivered to a consumer via the portable memory media (e.g., a DVD, a flash drive, a memory stick, etc.) in a format compatible with the type of media player 20 provided at the publicly accessible site for accessing stored complementary digital content item (CDCI) 68 at node 33.

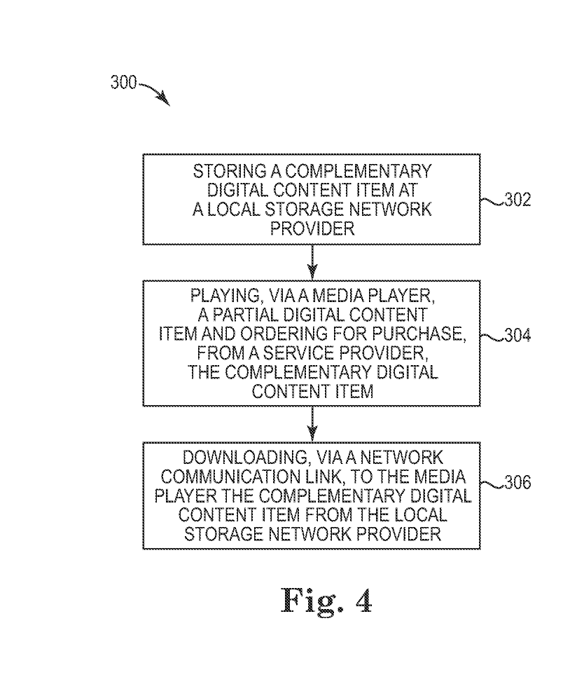

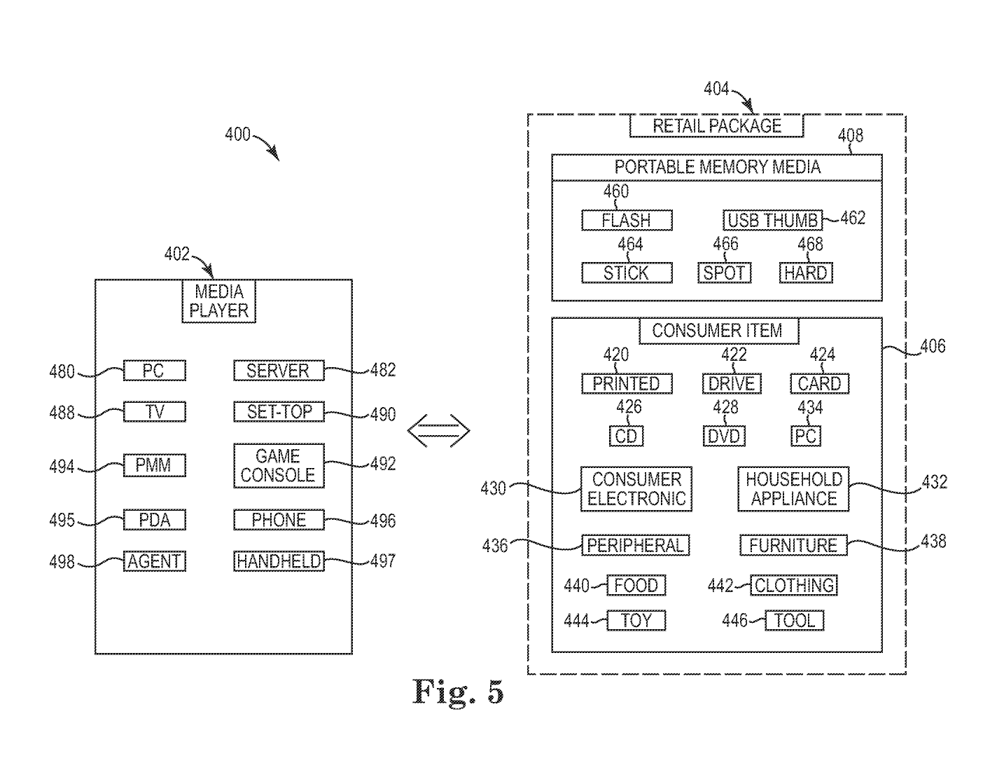

As described more fully in association with FIGS. 2 and 4, this transmission of complementary digital content item (CDCI) 68 and pre-population of peer-to-peer network 38 takes place in a time frame selected by promotion provider 12 to coincide, or be prior to, a consumer being able to purchase the DVD package 60 including the promotional DVD 64 that incorporates the partial digital content item (PDCI) 66.

As illustrated in FIG. 1, the media player 20 comprises a node 54 of the peer-to-peer network 38 established by the array 32 of nodes 33 and communication with the other nodes 33 via network communication link (NCL) 34. In addition, in one aspect, media player 20 comprises an agent 50 configured to control communication to and from the media player 20 when media player 20 acts as node 54, including control over storage and access to digital content items by peers 33 of the network 38 under the direction of the storage network provider 16. In another embodiment, in the case in which the consumer owns a media player 20 not equipped with agent 50, the promotional DVD 64 of DVD package 60 comprises a software agent, performing substantially the same functions as agent 50 of media player 20. Upon loading the promotional DVD 64, the software agent establishes control and communication channels with storage network provider 16 and nodes 33 of the peer-to-peer network 38 under the control of storage network provider 16.

In one embodiment, storage network provider 16 comprises a controller 36 that establishes the relationship between the nodes 33 and directs the communication between the nodes 33 to enable storing digital content items throughout the nodes 33 of the network. Of course, controller 36 implements security provisions to prevent each node 33 (as well as node 54 of media player 20) from compromising the digital content items or the authority of controller 36 in regulating the nodes 33 regarding the digital content items.

Accordingly, with this arrangement, the complementary digital content item (CDCI) 68 is downloaded to media player 20, as represented by path 6 in FIG. 1, for storage and/or playing.

As previously described, the consumer plays the promotional DVD 64 on their media player 20 and views the partial digital content item (PDCI) 66. If the consumer likes the subject matter of the partial digital content item (PDCI) 66, the consumer purchases the complementary digital content unit (CDCI) 68 via a user interface of the media player 20, as supported via agent 50 of media player 20 (or of promotional DVD 64), for downloading from peer-to-peer network 38 (as represented by path 6). In one embodiment, agent 50 of media player 20 and/or storage network provider 16 is configured to simplify the transaction via a subscription arrangement, a one-click user interface, or another suitable consumer-friendly transaction mechanism.

In another embodiment, in which media player 20 does not comprise a node in peer-to-peer network 38 or in which the peer-to-peer network 38 is temporarily unavailable, the media player 20 downloads the complementary digital content item (CDCI) 68 via network communication link (NCL) 34 via path 7 as illustrated in FIG. 1. While this electronic delivery pathway is slower, the consumer still obtains access to the complementary digital content item (CDCI) 68.

In one embodiment, the first portion of the first digital content item is a clear text segment configured without copying restrictions and the second portion of the first digital content is a digital rights management segment configured with security and copying restrictions. Accordingly, the partial digital content item (PCDI) 66 is freely accessible by consumers and easily handled by promotion provider 12 and custom media provider 14 during manufacture of promotional DVD 64. However, the complementary digital content item (DCDI) 68 is protected from abuse by consumers, nodes 33 of peer-to-peer network 38, custom media provider 14 or promotion provider 12.

FIG. 2 is a block diagram of promotion provider 100, according to one embodiment of the present disclosure. In one embodiment, promotion provider 100 comprises substantially the same features and attributes of promotion provider 12, as previously described in association with FIG. 1. As illustrated in FIG. 2, promotion provider 100 comprises campaign target module 102, implement module 104, and media package module 106.

Campaign target module 102 of promotion provider 100 enables promotion provider 100 to direct its promotional campaign at one or more targets. In one embodiment, as illustrated in FIG. 2, campaign target module 102 comprises temporal parameter 120, a release module 122, a locality identifier parameter 124, and a demographics parameter 126.

In one aspect, the temporal parameter 120 is configured to time the release of the promotional DVD 64, as part of DVD package 60, to target a particular time of the year (e.g., summer, Christmas, Halloween) or to target a particular weekend, such as Labor Day weekend.

In another aspect, the release module 122 is configured to target a release of another digital content item, and comprises a DVD release parameter 140, a theatre release parameter 142, a television (TV) release parameter 144, and a media-on-demand (MOD) release parameter 146. The DVD release parameter 140 is configured to select release of the promotional DVD 64 to coincide with release of a main DVD title (which may or may not be main DVD 62 of DVD package 60). In another aspect, theatre release parameter 142 is configured to select the release of the promotional DVD 64 to generally coincide with a theatre release of a different digital content item. In another aspect, television release parameter 144 is configured to select the release of the promotional DVD 64 to generally coincide with television release of a different digital content item while media-on-demand (MOD) release parameter 144 is configured to select the release of the promotional DVD 64 to generally coincide with a media-on-demand release of a different digital content item.

The locality identifier parameter 124 of campaign target module 102 is configured to enable promotion provider 100 to select and identify, for the custom media provider 14, a locality in which the promotional DVD 64 (and the DVD package 60) is to be released. In addition, this locality identifier is provided to storage network provider 16 to facilitate pre-populating the complementary digital content item (CDCI) 68 (FIG. 1) among the nodes 33 of the peer-to-peer network 38 in the vicinity or locality in which the promotional DVD 64 is being released to the DVD retailer 18. In addition, this locality identifier is made known to a mail retailer 42 of DVD retailer 18 (FIG. 1) so that a DVD package 60 with an appropriate locality identifier is shipped to the consumer.

The demographics parameter 126 of campaign target module 102 enables the promotion provider 100 to target groups (e.g. college age males) within the population, in cooperation with the locality identifier parameter 124 (e.g., a college area or college town) or with the release parameter 122 (e.g., spring break), to which the promotional DVD 64 is intended.

While the release of the promotional DVD 64 generally coincides with and targets an aspect of a promoted release of a digital content item, it is understood that the targeted release of the promotional DVD 64 also can precede the promoted release of the other digital content item.

Implement module 104 of promotion provider 100 is configured to enable the promotion provider 100 to orchestrate the timing and logistics of delivering the promotional DVD components to the custom media provider 14 and thereby time the release to the DVD retailer 18. In one embodiment, as illustrated in FIG. 2, implement module 104 comprises storage pre-load function 160 and schedule module 162, which includes demand parameter 164, cost parameter 166, infrastructure parameter 168, and profile parameter 170. In one aspect, the storage pre-load function 160 enables the promotion provider 100 to account for the lead time and coordinated planning with storage network provider 16 to pre-populate the peer-to-peer network 38 with the complementary digital content item (CDCI) 68 so that it is available for downloading when the consumer is viewing the partial digital content item (PDCI) 66 stored on the promotional DVD 64.

In one aspect, the demand parameter 164 enables the promotion provider 100 to account for a demand forecast for particular digital content items or types of digital content items so that custom media provider 14 is able to manufacture an appropriate number of promotional DVDs 64 and so that storage network provider 16 has an appropriate number of nodes 33 available for storing the complementary digital content item (CDCI) 68.

In another aspect, cost parameter 166 enables promotion provider 100 to account for the cost of the implementation of the campaign while infrastructure parameter 168 accounts for the available resources so that the campaign is appropriately scaled to match the capacity of the infrastructure of the local storage network. In one aspect, profile parameter 170 enables the promotion provider 100 to consider a demographic profile of known consumers and potential consumers in making selections for the other parameters, functions, and modules of the promotion provider 100.

Media package module 106 of promotion provider 100 is configured to select and package together digital content components to enable custom media provider 14 (FIG. 1) to produce DVD package 60 illustrated in FIG. 1. Accordingly, in one embodiment, as illustrated in FIG. 2, media package module 106 comprises main DVD module 180, promotional DVD module 182, and incentive function 184. The main DVD module 180 enables promotion provider 12 to select one or more main DVDs to which a promotional DVD 64 will be paired. For instance, in one example, several (e.g. three, four, or five) different DVD packages 60 are produced wherein each DVD package 60 includes the same promotional DVD 64 but a different main DVD 62. This arrangement allows leveraging the promotional DVD 64 to reduce its cost per volume while cross-marketing the partial digital content items on the promotional DVD 64 to a variety of potential consumers. Accordingly, the provision of promotional DVD 64 is scalable across multiple release events, as well as different localities.

The promotional DVD module 182 is configured to enable the promotion provider 100 to select components for delivery to custom media provider 14 for inclusion onto the promotional DVD 64. Foremost, the promotional DVD module 182 is configured to take a full length digital content item, such as a movie, and separate the digital content item into a first portion and a second portion. The promotion provider 100 typically provides the custom media provider 14 (FIG. 1) with the first portion, such as first chapter of a movie, with this first portion corresponding to the partial digital content item (PDCI) 66. The promotion provider 100 then retains the second portion, which corresponds to the complementary digital content item (CDCI) 68, for later delivery to the storage network provider 16 to be made accessible for download by the consumer via media player 20.

In addition, in one embodiment as illustrated in FIG. 2, the promotional DVD module 182 comprises a trailer parameter 192, an advertisement (AD) parameter 194, a photo parameter 196, and a bonus material parameter 198. The trailer parameter 192 is configured to select a movie screener, video trailer, or other sample of a digital content item for inclusion onto the promotional DVD 64. The advertisement parameter 194 is configured to select an advertisement regarding the digital content item while the photo parameter 196 enables selection of a photo for inclusion onto promotional DVD 64. The bonus material parameter 198 enables inclusion of bonus tracks, such as technical effects, games, actor interviews, etc.

In one embodiment, the digital content components selectable via promotional DVD module 182 are supplied by a content provider (not shown) so that promotion provider 100 need not create and produce these digital content components. However, in another embodiment aspect, promotional provider 100 acts as its own content provider and creates and produces some or all of the digital content components available for inclusion onto promotional DVD 64.

In another aspect, the incentive function 184 of promotion provider 100 is configured to enable selection for inclusion with the promotional DVD 64 in DVD package 60 one or more coupons, rebates, voucher, or other incentives tailored to the entice consumer to purchase a complementary digital content item (CDCI) 68 or to participate in the release of another digital content item (e.g., a theatre movie release, a DVD retail release, etc.).

FIG. 3 is a block diagram of a node 250 of a peer-to-peer network, according to one embodiment of the present disclosure. In one embodiment, node 250 comprises substantially the same features and attributes as node 33, as previously described in association with FIG. 1.

As illustrated in FIG. 3, node 250 comprises storage module 260, security function 264, schedule function 266, locality identifier parameter 268, protocol function 270, media player 280, and public site function 282. In one aspect, storage module 260 is configured to store one or more digital content items 262 (e.g. a complete digital content item or complementary digital content item 68) at node 250 as part of its role as a node 33 in peer-to-peer network 33 (FIG. 1). In another aspect, security function 264 enables storage network provider 16 to maintain control over the access to digital content items 262 in storage module 260 of node 250 for the exclusive use of storage network provider 16 to limit the downloading of the digital content items to consumers that have purchased a DVD package 60 including a promotional DVD 64 or to other regular customers.

In one aspect, schedule function 266 resides on node 250 to facilitate scheduling of the storage space and downloading functions (under the control of storage network provider 16) in cooperation with scheduling requested by promotion provider 100 via its schedule module 162. In another aspect, the identifier parameter 268 stores a locality identifier to enable the promotion provider 100, in cooperation with the storage network provider 16, identify its geographic location for use in selecting nodes to store a particular complementary digital content item (CDCI) 68 to coincide with the expected geographic location at which the promotional DVD 64 will be released.

In one aspect, the media player function 280 represents the situation in which node 250 functions as a media player 20, in addition to its role as a node 250.

In one aspect, protocol function 270 of node 250 enables the storage network provider 16 to direct communication between nodes 33 and control over the nodes 33 according to a protocol for directing the storage of digital content items intended for download. This protocol insures a separation between any private storage and private actions by an owner/operator of a node 33 relative to the network storage and actions directed by storage network provider 16.

In one embodiment, node 250 comprises a public site function 282 in which node 250 (e.g. a node 33 of network 38 in FIG. 1) is pre-populated with or stores a complementary digital content item (CDCI) 68 and node 250 comprises a publicly accessible site or is co-located with a public site. Accordingly, this publicly accessible site of node 250 includes, but not limited to, a Wi-Fi® hot spot, an internet cafe, a restaurant internet access site, a public facility access site, or an internet access rental kiosk. In one aspect, promotional content including a partial digital content item (PDCI) 66 is delivered to a consumer via the portable memory media (e.g., a DVD, a flash drive, a memory stick, etc.) in a format compatible with the type of media player 20 provided at the publicly accessible site (via public site function 282) for accessing stored complementary digital content item (CDCI) 68 at node 250.

FIG. 4 is a flow diagram of a method 300 of distributing digital content, according to an embodiment of the present disclosure. In one embodiment, method 300 is performed using any one of the embodiments previously described in association with FIGS. 1-3. In one embodiment, as illustrated in FIG. 4 at box 302, a complementary digital content item is stored at a storage network provider. In one aspect, the storage network provider comprises a peer-to-peer network in the geographic vicinity of a consumer targeted for DVD promotion of a partial digital content item related to the stored complementary digital content item.

As illustrated at box 304, a promotional DVD including a partial digital content is played, via a media player, and then the complementary digital content item is electronically purchased from a service provider in communication with the storage network provider. In one aspect, the complementary digital content item completes or succeeds the partial digital content item.

At box 306, the electronically purchased complementary digital content item is downloaded, via a network communication link, to the media player from the local storage network provider and the consumer views the complementary digital content item at media player.

In one embodiment, the partial digital content item (PDCI) 66 stored on a portable memory media is provided or sold with consumer items different than a DVD. In another embodiment, a type of portable memory media different than a DVD is used to store the partial digital content item (PDCI) 66. Accordingly, a great deal of freedom is accorded to promotion provider 12 and/or custom media provider 14 (see FIG. 1) in selecting the type of items that a promotional material (e.g., a partial digital content item 66) is paired with for sale and in the type of portable memory media used to store the partial digital content item (PDCI) 66.

Accordingly, FIG. 5 is a block diagram illustrating a digital content distribution system 400, according to one embodiment of the present disclosure. In one embodiment, system 400 comprises substantially the same features and attributes as the systems and method previously described in association with FIGS. 1-4, except for one DVD 64 (that stores the partial digital content item (PDCI) 66) being replaced by a different type of portable memory media and/or except for another DVD 62 (that stores a conventional digital content item) being replaced by a different type of consumer item. In all other respects, the promotion provider 12, custom media provider 14, storage network provider 16, and retailer 18 generally interact in the manner previously described in association with FIGS. 1-4. However, the DVD retailer 18 will not be limited to selling DVDs in DVD packages 60, but comprises any retailer selling any one or more of a wide range of consumer items.

As illustrated in FIG. 5, system 400 comprises a media player 402 and a retail package 404 that includes a consumer item 406 and a portable memory media 408.

In one embodiment, the retail package 404 is available for purchase at a retailer (e.g., brick-and-mortar, mail, or on-line) with retail package 404 including a consumer item 406 and at least one portable memory media 408. As illustrated in FIG. 5, the consumer item 406 includes, but is not limited to, a printed media item (e.g., a book) 420, a digital memory drive 422, a digital memory card 424, a photo or audio CD 426, a DVD 428, a consumer electronics appliance 430 (e.g. stereo, television, calculator, portable audio player, etc.), a household appliance 432 (e.g. refrigerator, stove, etc.), a personal computer (PC) 434, a computer peripheral 436 (e.g. printer, monitor, etc.), a furniture item 438, a packaged food item (FOOD) 440 (e.g., cereal snacks, beverages), a clothing item 442, a toy 444, or a tool 446.

As illustrated in FIG. 5, in one embodiment, in addition to the DVDs 60, 62 as illustrated in FIG. 1, the portable memory media 408 comprises a digital memory device that includes, but is not limited to, a flash card 460, a Universal Serial Bus (USB) thumb drive 462, a memory stick 464, a memory spot 466, or a portable hard drive 468.

Moreover, given the large number of different formats in which portable memory media 408 is provided, an appropriate media player 402 is provided for accessing the respective format of the portable memory media 408. Accordingly, as illustrated in FIG. 5, in one embodiment, the media player 402 includes, but is not limited to, a personal computer (PC) 480, a personal computer server (SERVER) 482, a television (TV) 488, a set-top box 490 (such as a DVR, satellite interface box, cable interface box, etc.), a game console 492, a portable media player (PMM) 494, a personal digital assistant (PDA) 495, a wireless phone (PHONE) 496, a handheld computer (HANDHELD) 497, or a software agent (AGENT) 498 on a hardware device.

By using any one of the many different formats of portable memory media 408, any one of the many different types of media players 402, and any one of the many different available consumer items 406, a promotion provider 12 (or custom media provider 14) has a wide variety of choices to distribute a partial digital content item (PDCI) 66 for sale and a wide variety of choices to distribute the complementary digital content item (CDCI) 68 for purchase to complement the partial digital content item (PDCI) 66.

Embodiments of the present disclosure provide for staged delivery of digital content items including a physical delivery pathway for a partial digital content item and an electronic delivery pathway for a complementary digital content item related to the partial digital content item. A promotional provider orchestrates the partial digital content item to be sold in a set or package with other main title DVDs (or other consumer items) and orchestrates the storage of the complementary digital content item in a local storage network to enable rapid downloading by the consumer. This convenience to the consumer is leveraged to promote multiple digital content items within the DVD market, as well as outside of the DVD market, such as in-theatre releases of movies. The promotional provider takes advantage of the current consumer behavior of purchasing a retail DVD package (or other retail package) to expose the consumer to additional partial digital content items included within the retail DVD package. This arrangement promotes other digital content items (e.g., theatre release movies) while simultaneously providing a vehicle to purchase and download the complementary digital content item related to the partial digital content item.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that the claimed subject matter be limited by the claims and the equivalents thereof.

What is claimed is:

1. A digital content distribution system comprising:
at least one portable memory media configured to be played on a media player and including a first portion of a first digital content item; and
a content delivery network configured to store a second portion of the digital content item that complements the first portion of the first digital content item and to download the second portion of the first digital content item to the media player.

2. The system of claim 1 wherein the media player comprises at least one of a DVD player, a personal computer, a personal server, a television, a set-top box, a game console, a portable media player, a personal digital assistant, a wireless phone, a handheld computer, or a software application on a hardware device.

3. The system of claim 1 wherein the at least one portable memory media comprises a digital memory device including at least one of a flash card, a USB thumb drive, a memory stick, a portable hard drive, or a memory spot.

4. The system of claim 1, wherein the at least one portable memory media comprises a first DVD, and the system further comprises a multi-disc set of DVDs including the first DVD and a second DVD, wherein the first DVD includes the first portion of the first digital content item and wherein the second DVD includes a complete second digital content item different than the first digital content item.

5. The system of claim 1 and further comprising:
a retail package including a consumer item and the at least one portable memory media, wherein the consumer item includes at least one of a printed media item, a digital memory drive, a digital memory card, a photo CD, an audio CD, a DVD, a consumer electronics appliance, a household appliance, a personal computer, a computer peripheral, a furniture item, a food item, a clothing item, a toy, or a tool.

6. The system of claim 1 wherein the at least one portable memory media includes a distribution locality identifier configured to identify a geographic region in which the at least one portable memory media was released in retail stores.

7. The system of claim 6 wherein the content delivery network comprises:
a peer-to-peer local storage network including:
at least one storage network provider located in a geographic region substantially the same as the geographic region of the distribution locality identifier of the at least one portable memory media; and
a plurality of nodes, wherein the second portion of the first digital content item is stored in at least one of the respective nodes and the media player comprises one node of the plurality of nodes.

8. The system of claim 7 wherein the at least one of the respective nodes comprises a publicly accessible site including at least one of a Wi-Fi hot spot, an internet café, a restaurant internet access site, a public facility access site, or an internet access rental kiosk.

9. The system of claim 7 wherein the nodes are configured to store the second portion of the first digital content prior to a release of the at least one portable memory media.

10. The system of claim 7 wherein at least one of the media player and the at least one portable memory media includes an agent configured to identify and communicate with the nodes of local storage network and to enable downloading the second portion of the first digital content item to the media player.

11. The system of claim 7, further comprising:
a promotion provider configured to produce the first portion and the second portion of the first digital content item and to distribute the first portion of the digital content item for inclusion on the at least one portable memory media and to distribute the second portion of the first digital content item for pre-populating the second portion of the first digital content item at nodes of the peer-to-peer network.

12. The system of claim 11 wherein the promotion provider comprises an implementation module including:
a storage pre-load module configured to identify and initiate storage of the second digital content item in the peer-to-peer local storage network; and
a schedule module configured to select and implement a schedule for distributing the first and second portions of the first digital content item, in cooperation with the storage pre-load module, wherein the schedule module comprises at least one of:
a profile parameter configured to shape the schedule according to a demographics profile of a targeted group of consumers;
a demand parameter configured to shape the schedule according to a demand forecast for the second digital content item;
a cost parameter configured to shape the schedule according to a cost of implementing the storage pre-loading of the second digital content; or
a local network parameter configured to shape the schedule according to an infrastructure capacity of the peer-to-peer local storage network.

13. The system of claim 11 wherein the promotion provider comprises:
a campaign target module configured to direct a promotional campaign based on the at least one portable memory media toward a target, the campaign target module including:
a temporal parameter configured to initiate the promotional campaign based on a calendar event or a calendar season; and
a release function configured to initiate the promotional campaign based on at least one of:
a DVD retail release;
an in-theatre release;
a television broadcast release;
a media-on-demand release including movies-on-demand release or a pay-per-view release.

14. The system of claim 11 wherein the promotion provider comprises a media package module including:
a main content parameter configured to select at least one full length digital content item for inclusion into a DVD format package; and
a promotional content parameter configured to select for inclusion into the DVD format package, along with the first portion of the first digital content item, at least one of:
a movie screener;
a video trailer;
an advertisement; or
a photo; and
an incentive parameter configured to select, for inclusion into the DVD format package, at least one of a coupon, a voucher, or a rebate.

15. The system of claim 1 wherein the first portion of the first digital content item is a clear text segment and the second portion of the first digital content is a digital rights management segment of the first digital content.

16. The system of claim 1 wherein the at least one portable memory media comprises a release date and the first digital content item includes at least one of a subject matter or a genre that is substantially related to a second digital content item being released in a theatre in a time period substantially the same as the release date of the at least one portable memory media.

17. A method of distributing digital content comprising:
storing a complementary digital content item at a local storage network provider;
playing, via a media player, a partial first digital content item on a first portable memory media and ordering for purchase, from a service provider, the complementary first digital content item; and
downloading, via a network communication link, to the media player the first complementary digital content item from the local storage network provider.

18. The method of claim 17 wherein storing the complementary digital content item comprises:
storing, in advance of a retail release of the first portable memory media, the complementary first digital content item at a plurality of nodes of a peer-to-peer storage network, with the media player comprising one of the respective nodes of the peer-to-peer storage network.

19. The method of claim 17, comprising:
providing a first DVD package to a retailer from a custom media provider, the first DVD package including the first portable memory media storing the partial first digital content item and a second DVD storing a full length second digital content item, the full length second digital content item different than either the complementary first digital content item or the partial first digital content item.

20. The method of claim 19, comprising:
distributing, among a plurality of DVD retailers, a plurality of DVD packages including the first DVD package with each respective DVD package including the partial first digital content item on the first portable memory media and a different second digital content item.

21. The method of claim 19, comprising:
distributing, among a plurality of DVD retailers, a plurality of DVD packages including the first DVD package with each respective DVD package including the second digital content item and at least one of a plurality of different partial digital content items, the plurality including the partial first digital content item.

22. The method of claim 19 wherein distributing the plurality of DVD packages comprise targeting the distributing of the respective DVD packages to at least one target geographic location corresponding to a geographic location of the peer-to-peer storage network.

23. A digital content distribution system comprising:
means for packaging, for sale via a retailer, a first consumer item and a portable memory media including a partial digital content item;
means for accessing the portable memory media to view the partial digital content item;
means for purchasing a complementary digital content item related to the partial digital content item; and
means for downloading, to the means for accessing, the complementary digital content item for viewing via the means for accessing.

24. The system of claim 23 wherein the means for accessing comprises a media player and the means for purchasing comprises a service provider in communication with the means for accessing via a network communication link.

25. The system of claim 23 wherein the means for downloading comprises a peer-to-peer storage network including a plurality of storage nodes in communication with the means for accessing, wherein the means for accessing comprises one storage node of the respective storage nodes of the plurality of storage nodes.
